(19) United States
(12) Patent Application Publication
(10) Pub. No.: US 2009/0129087 A1
(43) Pub. Date: May 21, 2009

(54) Light System and Method to Thermally Manage an LED Lighting System

(76) Inventors: Carl R. Starkey, (US); James D. Matthews, East Moline, IL (US); William L. Carr, Bettendorf, IA (US)

Correspondence Address: HAMILTON IP LAW, PC, 331 W. 3RD ST., NEW VENTURES CENTER SUITE 120, DAVENPORT, IA, 52801, US

(21) Appl. No.: 12/272,019

(22) Filed: Nov. 17, 2008

Related U.S. Application Data
(60) Provisional application No. 61/003,216, filed on Nov. 15, 2007.

(51) Int. Cl. F21V 29/00

(52) U.S. Cl. 362/249.02; 362/373

(57) ABSTRACT

A method of cooling light emitting diode (LED) lighting systems and associated structures are disclosed and claimed herein. The method involves determining the areas of a printed circuit board (PCB) onto which LEDs will be mounted will have the highest temperature during operation and positioning thermal vias of a certain size in or adjacent that area. The thermal vias extend from the PCB first side through the PCB substrate to the PCB second side to allow fluid flow through the PCB. The thermal vias are coated with a plating so that thermal energy is conductively transferred from the area adjacent an LED or resistor to the thermal via. From the thermal via the thermal energy may be dissipated to the atmosphere adjacent the thermal via through various modes. Novel structures according to the present invention include LED circuits, light fixtures, PCBs, and various combinations thereof employing the thermal vias.

### CROSS REFERENCE TO RELATED APPLICATIONS

Applicant claims priority under 35 U.S.C. § 119(e) of provisional U.S. Patent Application Ser. No. 61/003,216 filed on Nov. 15, 2007, which is incorporated by reference herein.

### FIELD OF INVENTION

The invention relates generally to light emitting diode type lights and the thermal management of LED type lighting systems.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND

High bay lights are a type of high intensity discharge (HID) light that are suitable for general purpose lighting in areas such as warehouse facilities, assembly areas, gyms, hangars, transportation garages, and loading and staging areas. High bay lights or fixtures of the prior art are typically suitable for indoor applications in which ceiling height exceeds fifteen feet. Typical prior art high bay light fixtures are made by Howard Lighting. They may have a 1000 watt (W) metal halide bulb and a twenty-two inch (22″) aluminum reflector. The die-cast plate is often tapped three-quarter inch nominal pipe size (NPS) and accepts three-quarter inch pipe or a 715NEW die-cast hook for installation and positioning from a rafter or beam. According to the specifications for such lights, they often have a minus forty degrees Fahrenheit minimum starting temperature. The available power sources for such lights are 120, 208, 240, 277 and 480 volts.

U.S. Pat. No. 7,282,869 issued to Mayer et al. (the '869 patent, which is incorporated by reference herein) provides relevant background on other HID lights, of which the present art is intended to replace. HID lamps are used in many applications because of their long life and high efficiency. Principal types of HID lamps are high pressure sodium (HPS), pulse start metal halide (PSMH), and mercury vapor lamps.

Mercury vapor, metal halide, and HPS lamps all operate similarly during stabilized lamp operations. The visible light output results from the ionization of gases confined within an envelope and which must be broken down before there is any flow of ionization current. Accordingly, a high open circuit voltage must be applied to an HID lamp for igniting. This voltage is substantially higher than the operating voltage and the available line voltage. HID lamps also exhibit negative resistance. When operating, their resistance decreases with increase in the applied voltage. As a result, such lamps require an impedance means in their power supply to limit the alternating current flow to a predetermined value.

Because of the high starting or igniting voltage requirement and the negative resistance characteristic, HID lamps are provided with igniting and operating circuits, which provide a relatively high open circuit voltage and impedance means for current limitations. A ballast between the power supply and lamp typically serves as its impedance means in igniting and operating circuits for HID lamps. For HID lamps such as mercury vapor lamps, igniting voltages may be two times the operating voltage. The igniting voltage is generated by the ballast secondary coil winding. For HPS lamps, the required voltages may be more than ten times the operating voltages and more complex igniting mechanisms are employed.

The ballast system also typically provides for certain requirements when electronic igniters are used in conjunction with the HID lamps. For example, electronic igniters used in conjunction with HPS ballast coils produce a high voltage pulse to start the HPS lamp. These electronic igniters work by sensing whether the lamp is burning. If the lamp is not burning, the igniter continuously supplies starting pulses to the lamp, regardless of whether the lamp is not burning because of lamp failure, absence of a lamp in the lamp socket, or by the lamp cycling off.

Lamp cycling is a well-known phenomenon in which a lamp nearing the end of its life will light, turn on for some time, go out, relight, and repeat this cycle time after time until the lamp is replaced or the lamp will fail to start at all. In an HPS lamp, as the HPS lamp nears the end of its life, its lamp operating voltage gets so high that the ballast will no longer sustain operation, and the lamp cycling condition manifests itself.

From the foregoing, it is clear that certain problems may arise in the operation of HID lamps and associated ballasts. In certain situations, (e.g., when a lamp is cycling, failed, or is missing) the igniter in the lamp's HID circuit continues to operate. Such operation shortens igniter and ballast life due to the presence of continuous high voltage pulses that inflict unusual, extended stress on the lighting system. The result of this stress on the ballast transformer may result in burning or smoking, and/or damaged HID lamp fixtures and wiring. Cycling lamps in need of replacement may avoid replacement if the lamp is in an illuminated state when inspected, and thus cause future maintenance problems.

Because many times HID lamps are used in roadway lighting, manufacturing installations with high/inaccessible ceilings, military installations, aircraft hangars, parking lots, tennis courts, athletic arenas and the like, replacement of a failed lamp installation may also be time consuming and require specialized access equipment not always immediately available. Maintenance and operational inspections may be infrequent. Often, replacement of the lamp of a failed lamp installation is the first step. If the lamp is not the cause of the lamp outage, the cause may be a failed igniter or failed ballast or both. The cause may not be determined until the failed element is replaced and operating power is applied.

The lights of the prior art, such as those described in the '869 patent, also require a large amount of energy for the light produced (i.e., HID lights are not energy efficient). Additionally, the light produced may have a yellow tinge that is common for fluorescent-based lights. By contrast, light emitting diodes (LEDs) are efficient at converting electrical energy into light. Furthermore, LEDs may produce a high intensity white light that many users prefer.

The many advantages of LEDs are numerous and well known to those of ordinary skill in the art. LEDs produce more light per watt than do incandescent bulbs. LEDs may emit light of an intended color without the use of color filters that traditional lighting methods require. This is more efficient and may lower initial costs. The solid package of an LED may be designed to focus its light. Incandescent and fluorescent sources often require an external reflector to collect light and direct it in a usable manner. When used in applications where dimming is required, LEDs do not change their color tint as the current passing through them is lowered, unlike incandescent lamps, which turn yellow.

LEDs are ideal for use in applications that are subject to frequent on-off cycling, unlike fluorescent lamps that burn out more quickly when cycled frequently, or HID lamps that require a significant time before restarting. LEDs, being solid state components, are difficult to damage with external shock. Fluorescent and incandescent bulbs are easily broken if dropped on the ground. LEDs have an extremely long life span. One manufacturer has calculated the ETTF (Estimated Time To Failure) for their LEDs to be between 100,000 and 1,000,000 hours. Fluorescent tubes typically are rated at about 30,000 hours, and incandescent light bulbs at 1,000-2,000 hours. LEDs mostly fail by dimming over time rather than the abrupt burn-out failing associated with incandescent bulbs. LEDs light up very quickly. A typical red indicator LED will achieve full brightness in microseconds; LEDs used in communications devices may have even faster response times.

LEDs may be very small and are easily populated onto printed circuit boards (PCB). LEDs do not contain mercury, while compact fluorescent lamps do. However, before the creation and disclosure of the present art, it has not been economical nor practical to use LEDs in combination with a high bay light fixture for replacement of HID lights or fixtures. LEDs are known to produce a significant amount of heat during operation, and methods of thermal management of LEDS are lacking. This heat lowers the efficiency of light generation, thereby increasing power use and costs. Furthermore, the ambient temperature of the air surrounding the light fixture may decrease overall energy efficiency of the structure in which the fixture is located. Optical drift (i.e., deterioration of the quality of the light produced) is another result of the heat produced by the prior art configurations of LEDs. A method of thermal managing LED lighting systems is desirable as is an HID composed of LEDs.

### BRIEF DESCRIPTION OF DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 provides a perspective view of an LED light fixture configured for an application similar to those of prior art HID lights.

FIG. 2 provides a detailed view of an exemplary embodiment of the printed circuit board first side without LEDs installed.

FIG. 3 provides a top view an exemplary embodiment of a PCB first side without LEDs or resistors installed thereon.

FIG. 4 provides a perspective view of an exemplary embodiment of a printed circuit board first side to which multiple LEDs are attached.

FIG. 5 provides a detailed view of an exemplary embodiment of a portion of the printed circuit board second side with LEDs installed.

FIG. 6 provides a perspective view of an exemplary embodiment of the entire printed circuit board second side with LEDs installed.

FIG. 7 provides cross-sectional view of a portion of an exemplary embodiment of a PCB showing the orientation of the conductive pathways with respect to the plating.

FIG. 8 provides a schematic view of one embodiment of an LED circuit that may be used with the LED light fixture.

FIG. 9 provides a schematic view of one embodiment of an LED board section.

FIG. 10 provides a thermal map of an LED pad from the exemplary embodiment during use.

### DETAILED DESCRIPTION

### Listing of Elements

| ELEMENT DESCRIPTION | ELEMENT # |
|---|---|
| LED Light Fixture | 10 |
| Housing | 12 |
| Switched Mode Power Supply | 15 |
| Wire | 16 |
| Hanger | 18 |
| Printed Circuit Board (PCB) | 20 |
| PCB Substrate | 21 |
| PCB First Side | 22 |
| PCB Second Side | 24 |
| Electrical Lead Aperture | 26 |
| Thermal Via | 28 |
| Power Conductive Pathway | 30a |
| Ground Conductive Pathway | 30b |
| Power Connection | 31a |
| Ground Connection | 31b |
| Non-Conductive Area | 32 |
| LED Pad | 34 |
| Resistor Pad | 36 |
| Plating | 38 |
| Light Emitting Diode (LED) | 40 |
| LED Lead | 42 |
| LED Circuit | 44 |
| LED Board Section | 46 |
| Resistor | 50 |
| Electrical Energy Source | 52 |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

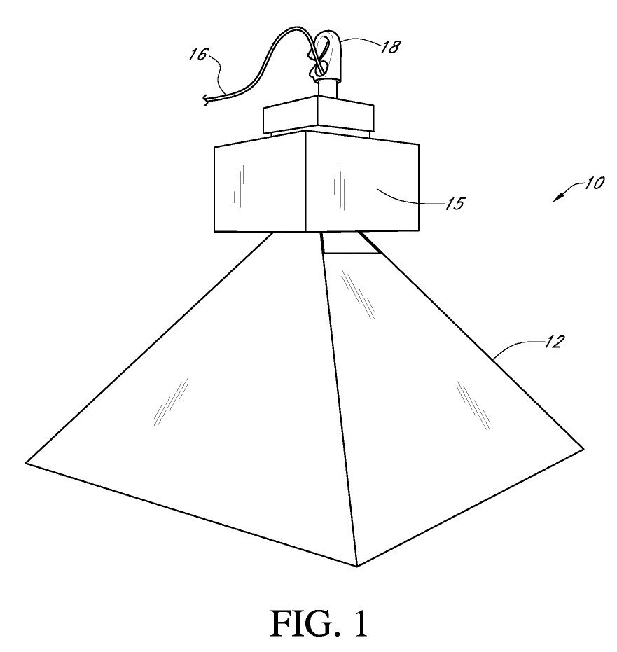

An LED light fixture 10 in accordance with the present disclosure is shown in FIG. 1. The LED light fixture 1 shown in FIG. 1 is configured for applications similar to the applications for which prior art HID lights (such as those described previously herein) are typically used. However, the LED light fixture 10 incorporates the benefits of LED lights and eliminates the disadvantages of prior art HID, both of which were described in detail above.

The amount and pattern of illumination produced during operation of the LED light fixture 10 may be tailored to the specific application for the LED light fixture 10 by means known to those skilled in the art. For example, different lenses (not shown) may be affixed to the housing 12 and used to direct the light in a certain pattern, and the amount of total illumination produced by the LED light fixture 10 may be predetermined by the number and intensity of LEDs 40 used in the LED light fixture 10, as well as the specific arrangement thereof. If a lens (not shown) is used, it may be configured to concentrate the light from the LEDs 40, to spread that light, or to manipulate that light in any other manner known to those skilled in the art. Furthermore, the color and quality of the light emitted by the LED light fixture 10 may be varied through the use of different LEDs 8, as is known to those skilled in the art. Accordingly, the LED light fixture 10 is not limited by the type of LED 40 used, and any LED 40 known to those skilled in the art may be used therewith out departing from the spirit and scope of the present invention. For example, the LED light fixture 10 may be configured to produce light that is bright and white, not yellow, as is common with prior art lighting systems. In another embodiment, the LED light fixture 10 may be configured to produce red or blue light, depending on the type of LED 40 used. The LED light fixture 10 provides for increased efficiency by increasing the amount of power converted to light, as compared to a typical HID light using metal halide or mercury vapor bulbs. Furthermore, the LED light fixture 10 configuration virtually eliminates optical drift during operation.

In the exemplary embodiment of the LED light fixture 10 as shown in the various figures, the LED light fixture 10 includes a housing 12 enclosing a portion of the internal components. A switched mode power supply 15 is mounted externally to the housing 12 to better mitigate heating caused by the switched mode power supply 15. However, in other embodiments the power supply may be mounted internally of the housing 12. In the exemplary embodiment, the switched mode power supply 15 is a Mean Well, brand model ASP-150 series, which is a 150 watt single output with PFC function. A wire 16 may be used to provide electrical energy from an electrical energy source to the switched mode power supply 15. As illustrated, and without limitation, the exemplary embodiment of the LED light fixture 10 as shown herein is for use with alternating current (AC) supplied at 50-60 Hz and 98-230 VAC. As those of ordinary skill in the art will appreciate, the present art may use other voltages, frequencies, and/or currents without limitation. A hanger 18 may be placed on the exterior of the housing 12 for mounting the LED light fixture 10.

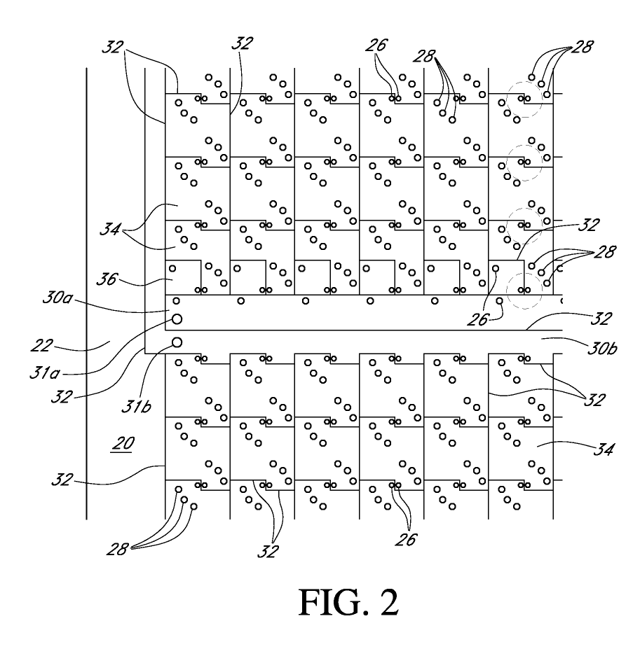

The housing 12 typically functions to protect and support the circuitry of the LED light fixture 10. A portion of the printed circuit board (PCB) 20 for use with the exemplary embodiment is shown in FIG. 2, wherein the dashed circles represent areas in which LEDs 40 may be placed, as described in detail below. The PCB 20 includes a PCB substrate 21 that is constructed of an electrically insulating material. The PCB substrate 21 of the exemplary embodiment as shown herein may be constructed of any insulation material suitable for a particular application, including pre-impregnated (commonly referred to as “prepreg”) combinations such as glass fiber mat, nonwoven material, and resin. As is known to those skilled in the art, the copper foil and prepreg are typically laminated together with epoxy resin to produce the PCB 20. Well known prepreg materials used in PCB industry include FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (woven glass and epoxy), CEM-4 (woven glass and epoxy), and CEM-5 (woven glass and polyester). Other widely used materials are polyimide, Teflon®, and some ceramics, of which any may be used without limitation, as required by particular application of the LED light fixture 10.

The PCB 20 of the exemplary embodiment, shown from various vantages in FIGS. 2-7, includes a first and a second side, 22, 24. In the exemplary embodiment, the positioning of the power conductive pathways 30a, ground conductive pathways 30b, LED pads 34, and resistor pads 36 is the same on the PCB first side 22 as it is on the PCB second side 24. That is, for each conductive pathway 30a on the PCB first side 22, there is a corresponding conductive pathway 30a mirrored on the PCB second side, and so on for the ground conductive pathways 30b, LED pads 34, and resistor pads 36. However, in other embodiments, the positioning of complementary components may be different from the PCB first side 22 to the PCB second side 24, or there may be no complementary components from the PCB first side 22 to the PCB second side 24. Furthermore, in such embodiments there may be more of a certain component on the PCB first side 22 than there is on the PCB second side 24 or vice versa, depending on the application for the LED light fixture 10.

A power conductive pathway 30 may be electrically connected to the switched mode power supply 15 through a power connection 31a, which is best shown in FIG. 2, through solder, wires, or any other method known to those skilled in the art. Also shown in FIG. 2 is a ground conductive pathway 30b, which may be electrically connected to the switched mode power supply 15 through a ground connection 31b in a manner similar to the electrical connection described above for the power connection 31a. Each power connection 31a and ground connection 31b are formed as apertures extending from the PCB first side 22 through the PCB substrate 21, and terminating at the PCB second side 24. Both the power and ground connections 31a, 31b are coated with a plating 38 that is electrically conductive. As shown, non-conductive areas 32 electrically insulate the conductive elements on the PCB first and second sides 22, 24, which in include power conductive pathways 30a, ground conductive pathways 30b, LED pads 34, resistor pads 36, LEDs 40, resistors 50, electrical lead apertures 26, thermal vias 28, power connections 31a, and ground conductive areas 31b, all of which will be described in detail herein.

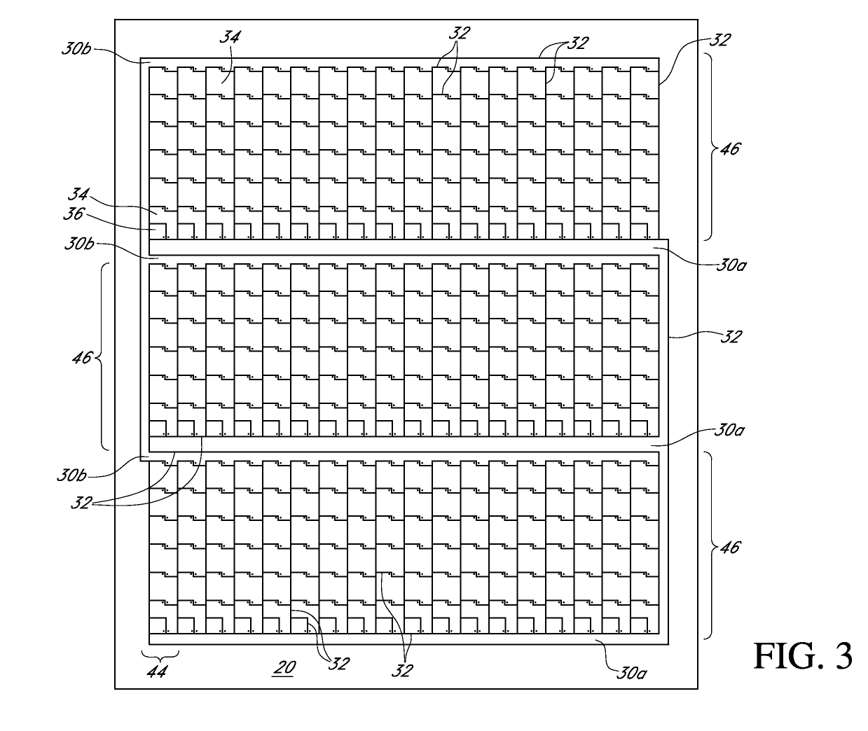

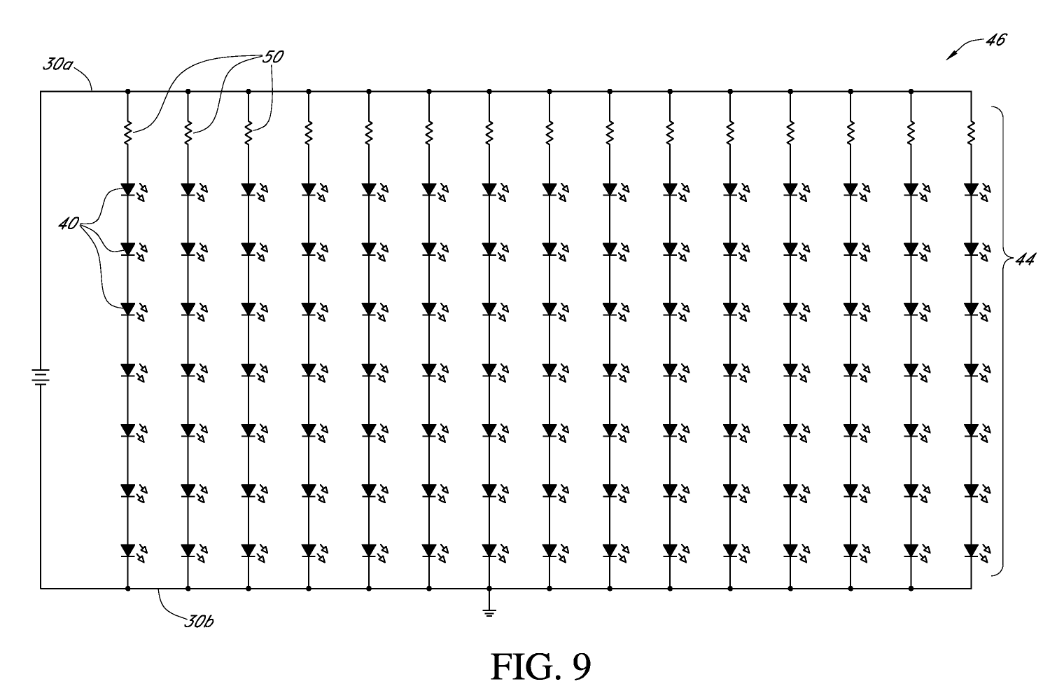

The entire PCB 20 from the exemplary embodiment is shown in FIG. 3 without any LEDs 40 or resistors 50 installed thereon, and without any electrical lead apertures 26, thermal vias 28, power connections 31a, or ground connections 31b formed therein. Accordingly, as described in detail above, the view in FIG. 3 may be of either the PCB first or second side 22, 24. From FIG. 3, it will be apparent to those skilled in the art that the PCB 20 is divided into three distinct LED board sections 46. Each LED board section 46 includes power and ground conductive pathways 30a, 30b, which may be electrically connected in parallel as shown herein. Each LED board section 46 in the exemplary embodiment includes eighteen individual LED circuits 44, which are electrically connected in parallel with the other LED circuits 44 of that particular LED board section 46. A schematic illustration of the exemplary embodiment of the LED board section 46 is shown in FIG. 9.

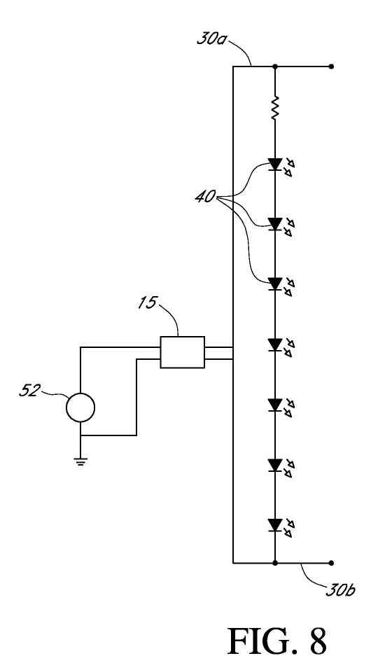

In the exemplary embodiment, each LED circuit 44 includes six LED pads 34, one resistor pad 36, one resistor 50, and seven LEDs 40, which yields a total of one hundred twenty six LEDs 40 per LED board section 46 in the exemplary embodiment. Each LED 40 and resistor 50 require two electrical lead apertures 26. Accordingly, the total number of LEDs 40 attached to the PCB 20 in the exemplary embodiment is three hundred seventy eight. A schematic illustration of the exemplary embodiment of an LED circuit 44 is shown in FIG. 8, wherein an electrical energy source 52 is electrically connected to the switched mode power supply 15. As shown in FIG. 2, the PCB 20 includes a plurality of resistor pads 36 positioned adjacent the power conductive pathway 30a. The resistor pads 36 are electrically insulated from other resistor pads 36, LED pads 34, power conductive pathways 30a, ground conductive pathways 30b, power connections 31a, and/or ground connections 31b by placement of non-conductive areas 32. In the exemplary embodiment, each power conductive pathway 30a includes one electrical lead aperture 26 for each LED circuit 44.

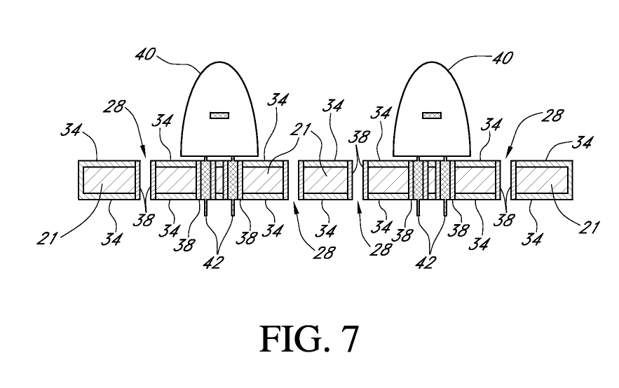

A cross-sectional view of a portion of the PCB 20 is shown in FIG. 7. From FIG. 7, it is clear that each electrical lead aperture 26 extends from the PCB first side 22 through the PCB substrate 21 to the PCB second side 24. Also, each electrical lead aperture 26 is coated with a plating 38 that is electrically conductive, and the diameter of each electrical lead aperture 26 is determined according to the electrical component that will be connected to the electrical lead aperture 26, and is therefore in no way limiting to the scope of the present invention. In the exemplary embodiment, each resistor pad 36 includes two electrical lead apertures 26. In the exemplary embodiment the resistor pad 36 is electrically connected to the power conductive pathway 30a by connecting one end of a resistor 50 to the electrical lead aperture 26 in the power conductive pathway 30a and the other end of the resistor 50 to the electrical lead aperture 26 in the resistor pad 36. In the exemplary embodiment, the resistors 50 each have a rating of 230 Kohm. However, as those skilled in the art will appreciate, the specifications of each resistor 50 is simply a design parameter that will vary depending on the other specifications of the components in each LED circuit 44. Accordingly, any number of resistors designed to have any amount of resistivity may be used with the LED light fixture 10 depending on the design thereof without departing from the spirit and scope of the present invention.

Adjacent the resistor pad 36 is an LED pad 34 having two electrical lead apertures 26; one adjacent the resistor pad 36 and one adjacent another LED pad 34. In the exemplary embodiment, the LED pad 34 of each LED circuit 44 that is located adjacent the resistor pad 36 is shaped differently from the other LED pads 34 in the LED circuit 44. However, the shape of the LED pads 34, resistor pads 36, power conductive pathways 30a, and ground conductive pathways 30b is in no way limiting, and may be different in embodiments not pictured herein depending on the specific application of the LED light fixture 10. The LED pad 34 adjacent the resistor pad 36 is electrically connected to the resistor pad 36 through an LED 40. As shown in FIG. 7, each LED 40 used in the exemplary embodiment has two LED leads 42. One LED lead 42 is positioned in the electrical lead aperture 26 in the resistor pad 36 and the other LED lead 42 is positioned in the electrical lead aperture 26 in the LED pad 34 adjacent the resistor pad 36.

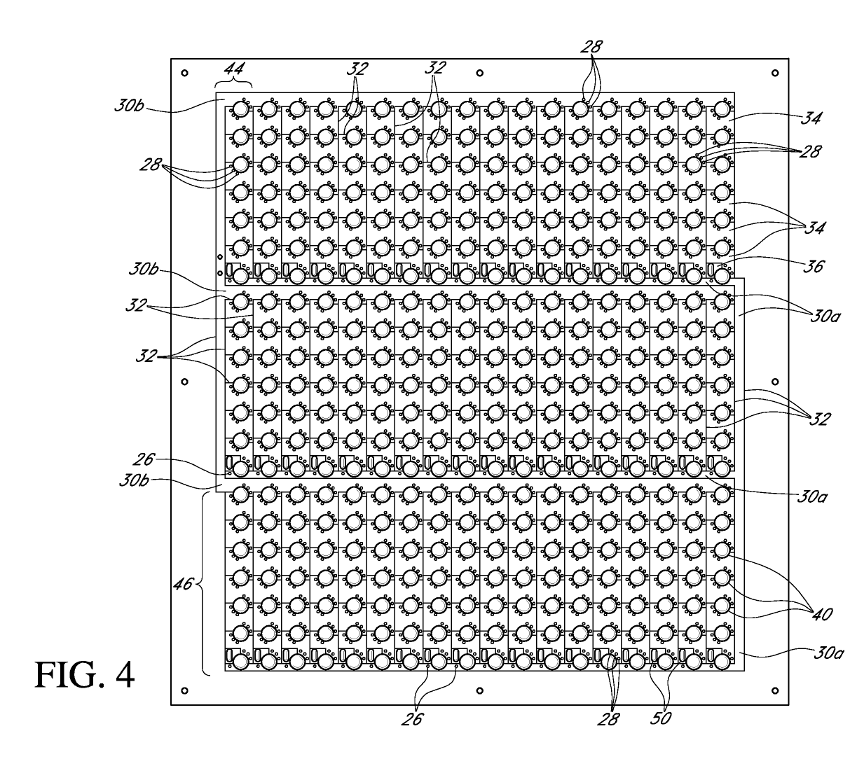

Another LED 40 electrically connects the LED pad 34 adjacent the resistor pad 36 to an LED pad 34 on the opposite side of the LED pad 34 adjacent the resistor pad 36, which is best shown in FIG. 2. To electrically connect the two LED pads 34, one LED lead 42 is positioned in the electrical lead aperture 26 in the LED pad 34 adjacent the resistor pad 36 while the other LED lead 42 is positioned in the electrical lead aperture 26 of the other LED pad 34. In this manner, the LEDs 40 of each LED circuit 44 are electrically connected to each other in series. The final LED 40 in each LED circuit 44 electrically connects the final LED pad 34 in the LED circuit 44 to the ground conductive pathway 30b in the same manner. In the exemplary embodiment, each LED circuit 44 includes seven LEDs 40 electrically connected in this manner in a linear configuration. However, depending on the switched mode power supply 15, PCB 20 design, and the specific application of the LED light fixture 10, the number of LEDs 40 in each LED light fixture 10 will vary, and is therefore in no way limiting to the scope of the present invention. For example, for use in an automobile, the structure employed to electrically connect each LED 40 to an electrical energy source 52 will likely be much different than the switched mode power supply 15 as shown in the exemplary embodiment herein. Accordingly, variations of the electrical energy delivery to each LED 40 and/or PCB 20 will occur to those skilled in the art without departing from the spirit and scope of the present invention. The PCB first side 22 is shown in FIG. 4 with the resistors 50 and LEDs 40 installed thereon. As is best shown in FIG. 2, the LED pads 34 are electrically insulated from other LED pads 34, power conductive pathways 30a, ground conductive pathways 30b, power connections 31a, ground connections 31b, and/or resistor pads 36 by placement of non-conductive areas 32.

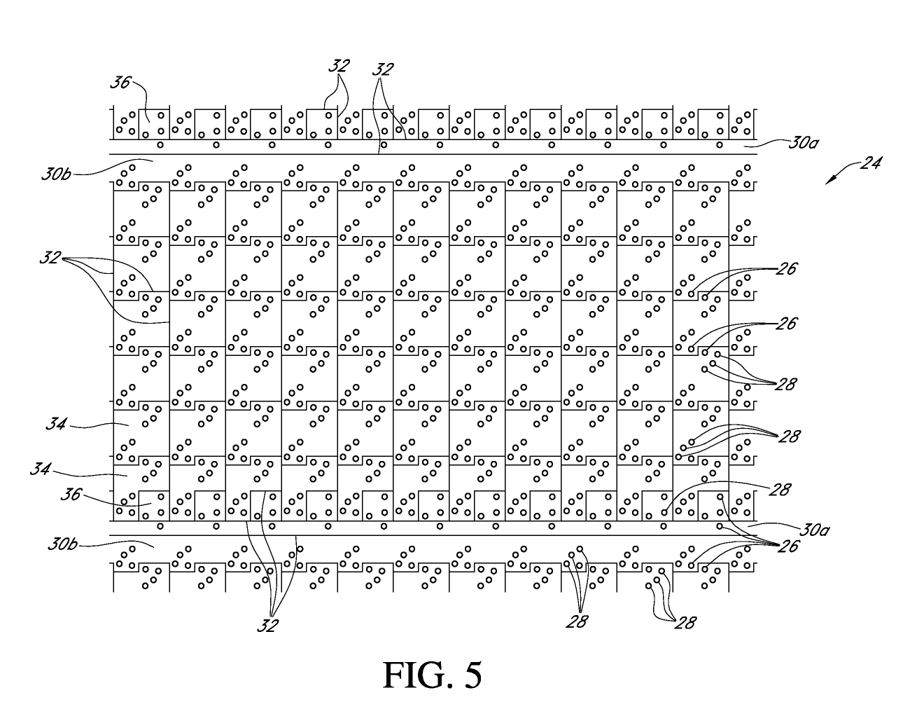

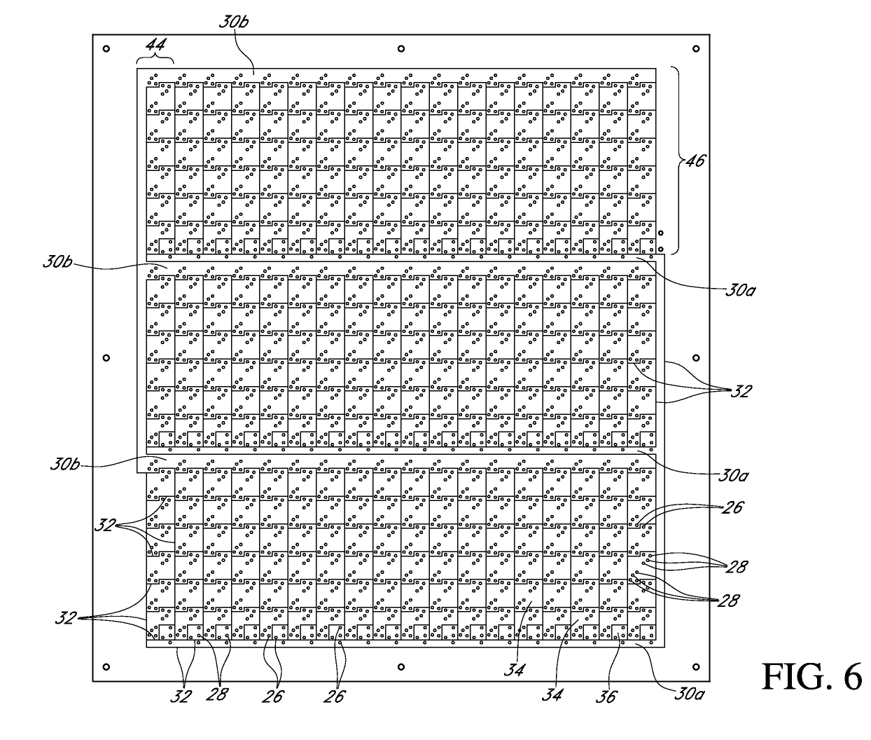

In the exemplary embodiment, the LED leads 42 are positioned on the PCB second side 24 and the bulb is positioned on the PCB first side 22. However, in other embodiments the LED leads 42 may be placed on the PCB first side 22. The PCB second side 24 of the exemplary embodiment with the LEDs 40 and resistors 50 installed thereon is shown in FIGS. 5-6. As may be seen from a comparison of FIGS. 5 and 2 (a detailed view of the PCB second side 24 and PCB first side 22, respectively), the PCB first and second side 22, 24 are configured identically with respect to the LED pads 34, resistor pads 36, non-conductive areas 32, power conductive pathways 30a, and ground conductive pathways 30b. Because the LEDs 40 and resistors 50 are installed in the PCB 20 in FIGS. 5-6, the electrical lead apertures are sealed with either an LED lead 42 or one end of the resistor 50.

In other embodiments not shown herein, the LEDs 40 may be electrically connected in a different manner that results in a different configuration, or they may be electrically connected in the same manner with a different configuration. For example, the LEDs 40 of each LED circuit 44 may be electrically connected to one another in series, but be configured in a curved or other non-linear manner. The LEDs 40 may also be electrically connected in parallel, but be configured in a curved or linear manner without departing from the spirit and scope of the present invention.

In the exemplary embodiment, the LEDs 40 are sold by BestHongKong under the part number BUWC5363W55BC26, ultra white in color, designated as 5363 10 mm Series 5 Chips Round LED Lamps. These LEDs 40 have a maximum peak forward current of 200 mA, a maximum DC forward voltage of 4.0 V, a maximum intensity luminous of 18,000 mcd, and a maximum color temperature of 10,000K. However, the LED light fixture 10 and PCB 20 may be configured to be used with any type of LED 40 known to those skilled in the art. The specifications of the LEDs 40 to be used with the present invention will depend on several factors, and will vary from one application to the next.

In the exemplary embodiment, three thermal vias 28 are positioned adjacent each LED 40 nearest the resistor pad 36 in each LED circuit 44, three thermal vias 28 are positioned adjacent each LED 40 nearest the ground conductive pathway 30b, and six thermal vias 28 are positioned adjacent the remaining LEDs 40 in each LED circuit 44. Each thermal via 28 extends from the PCB first side 22 through the PCB substrate 21 to the PCB second side 24. In this manner, the thermal vias 28 allow for fluid flow from the PCB first side 22 to the PCB second side 24 and vice versa, which dissipates heat generated through operation of the LED light fixture 10. Typically, the fluid will be air, but it may be any gas, vapor, liquid, or other fluid as the heat removal from the specific configuration of the PCB 20 requires, which will be dependent on design, as is well known to those skilled in the art. As shown in FIG. 5, a thermal via 28 may also be positioned adjacent each resistor pad 36.

Each thermal via 28 is coated with a plating 38 that is in thermal conductive communication with the LED pad(s) 34 and/or resistor pad(s) 36 in which the thermal via 28 is located, which is best shown in FIG. 7. In the exemplary embodiment, the plating 38 extends from the PCB first side 22 along each thermal via 28 and electrical lead aperture 26 to the PCB second side 24. However, in other embodiments not pictured herein, the plating 38 may not extend to the exterior of the PCB 20, depending on design parameters and the specific application. The section of the PCB 20 shown in FIG. 7 includes a total of four thermal vias 28, two LEDs 40, and four electrical lead apertures 26, through which LED leads 42 are positioned. Accordingly, as the temperature of the LED pads 34 and/or resistor pads 36 increase, thermal energy is transferred from the respective LED pads 34 and/or resistor pads 36 to the plating 38 coating the thermal vias 28 through conduction. Once the thermal energy reaches the exterior surface of the plating 38 in the thermal vias 28, the thermal energy may be dissipated through natural or forced convection into the area adjacent the thermal vias 28. The size, position, and number of thermal vias 28 will vary from one embodiment to the next, and those design parameters are in no way limiting to the scope of the present invention.

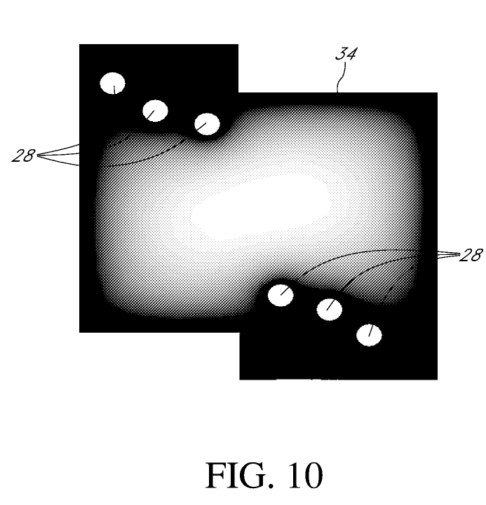

It is envisioned that the design of an LED light fixture 10 according to the present disclosure will begin with determining the luminosity requirements and space restraints for the LED light fixture 10. After this, a PCB of adequate physical size and electrical capacity will be designed for an LED 40 having certain specifications. Next, a mathematical model may be used to predict the locations of the PCB 20 that will have the highest amount of thermal energy. Another mathematical model may then be used to predict the heat transfer resulting from a certain number of thermal vias 28 having a certain size positioned in a certain location. These parameters may then be adjusted until the PCB 20 possesses the desired thermal gradient. A thermal map of one LED pad 34 (one which is not positioned on either respective end of an LED circuit 44) from the exemplary embodiment is shown in FIG. 10, wherein darker areas represent higher temperatures.

As will be apparent to those skilled in the art in view of the present disclosure, the power and ground conductive pathways 30a, 30b, LED pads 34, and resistor pads 36 are configured to maximize the ratio of surface area to mass of those respective components, which increases the heat dissipation efficiency of the PCB 20. Other configurations exist for embodiments not pictured herein, and such configurations will be dependent on the particular application for each LED light fixture 10. In certain embodiments, it is envisioned that the energy requirements for the LED light fixture 10 will be greater than that of the exemplary embodiment, in which case the power and ground conductive pathways 30a, 30b, LED pads 34, resistor pads 36, plating 38, and or LEDs 40 would be designed to withstand a larger load than those respective components in the exemplary embodiment. In other embodiments not picture herein, it is envisioned that the energy requirements for the LED light fixture 10 will be less than that of the exemplary embodiment, in which case the components listed above would be designed to withstand a lower load than those respective components in the exemplary embodiment.

### Exemplary Method of Construction

A method for constructing the exemplary embodiment will now be disclosed. However, the description that follows describes merely one method of many possible methods for making merely one exemplary embodiment of many possible embodiments of the invention, and is not therefore to be considered limiting as to the scope of the invention as disclosed and claimed herein.

After the space considerations and luminosity requirements have been determined, the configuration of LED pads 34, resistor pads 36, and power and ground conductive pathways 30a, 30b on the PCB first and second sides 22, 24 must be achieved, which will also determine the configuration of the LEDs 40. In the exemplary embodiment, this is accomplished by starting with a blank PCB 20 having a layer of electrically conductive material bonded to the PCB substrate 21 on both the PCB first and second sides 22, 24. The unwanted conductive material is removed and the LED pads 34, resistor pads 36, power conductive pathways 30a, and ground conductive pathways 30b are left, all of which are oriented according to the desired configuration and luminosity requirements for the LEDs 40. The unwanted conductive material may be removed from the PCB first and second sides 22, 24 through any method known to those skilled in the art, such as etching, milling, or any other method known to those skilled in the art. In other embodiments not pictured herein, the conductive pathways 26 may be made by adding conductive pathways 26 to a PCB substrate 21.

Next, or concurrently with removing unwanted conductive material, a plurality of apertures are fashioned in the PCB 20. These apertures extend from the PCB first side 22 through the PCB substrate 21 to the PCB second side 24. The number of apertures will depend upon the configuration of the LED light fixture 10. Each LED 40 in the exemplary embodiment requires two electrical lead apertures 26, as does each resistor 50. Each power and ground connection 31a, 31b also require an aperture, as does each thermal via 28. As previously explained, the number of LEDs 40 and thermal vias 28 for each LED light fixture 10 will vary depending on the specific application and design requirements.

The optimal number and placement of thermal vias 28 may be determined for any given configuration of LEDs 40 having known specifications using calculations known to those skilled in the art, as was described above. After a configuration of LEDs 40 has been determined (which is often performed prior to or concurrently with determining the configuration of the conductive material on the PCB first and second sides 22, 24), a heat profile may be estimated and thermal vias 28 may be fashioned on the PCB 20 in the areas having the highest projected temperature.

A solder mask may also be placed on the PCB first and second sides 22, 24 to protect the conductive material from the atmosphere. However, solder mask should not be positioned at any area of the PCB 20 that will later serve as an electrical connection or on the sides of any aperture in the PCB 20 that is designed to function as a thermal via 28. That is, solder mask is typically not placed on any area of the PCB 20 that will be coated with plating 38.

A thermally conductive plating 38 is then deposited on the PCB 20. The plating 38 is typically positioned on any portion of the PCB 20 that has not been covered by the solder mask. This may include portions of the PCB 20 adjacent electrical lead apertures 26 and the walls of electrical lead apertures 26, portions of the PCB 20 adjacent thermal vias 28 and the walls of thermal vias 28, and portions of the PCB 20 adjacent power and ground connections 31a, 31b and the walls thereof. Accordingly, in the exemplary embodiment the walls of the thermal vias 28, the ground and power connections 31a, 31b, and the walls of the electrical lead apertures 26 are covered with the plating 38. In the exemplary embodiment, this plating 38 is in electrical and thermal communication with the LED pad 34 or resistor pad 36 in which the thermal via 28 is positioned.

In this manner, the heat associated with operating the adjacent LED 40 may be thermally conducted to the thermal via 28 through the LED pad 34. From the thermal via 28, natural convection works in the exemplary embodiment to transport the heat from the thermal via 28 to the ambient atmosphere. In other embodiments, the plating 38 may be thermally conductive but not electrically conductive, and different plating 38 may be used on different elements of the PCB 20.

In experiments using the exemplary embodiment of an LED light fixture 10 as pictured herein, Applicant has measured a marked decrease in the operating temperature of the PCB 20. In identically configured LED light fixtures 10 using identical components, the average PCB 20 temperature for the LED light fixture 10 without thermal vias 28 was 148 degrees Fahrenheit after four hours of continuous operation; the average PCB 20 temperature for the LED light fixture 10 with thermal vias 28 was 120 degrees Fahrenheit after 10 hours of continuous operation.

An infinite number of electrical arrangements for the LED board sections 46, LED circuits 44, LED pads 34, resistor pads 36, power and ground conductive pathways 30a, 30b, and/or individual LEDs 40 within each LED circuit 44 are available to those skilled in the art within the spirit and scope of the present invention. For example, in certain applications the LED board sections 46 may be electrically connected in series rather than in parallel, as may be the LED circuits 44 within each LED board section 46 or individual LEDs 40 within each LED circuit 44. Accordingly, the precise electrical arrangement and/or configuration of the electrical lead apertures 26, thermal vias 28, power conductive pathways 30a, ground conductive pathways 30b, power connections 31a, ground connections 31b, non-conductive areas 32, LED pads 34, resistor pads 36, LEDs 40, LED circuits 44, LED board sections 46, and/or resistors 50 in no way limit the scope of the present invention.

In the exemplary embodiment as pictured herein, the power and ground conductive pathways 30a, 30b, LED pads 34, and resistor pads 36 are formed from copper traces, but may be any material known to those skilled in the art that is suitable for the specific application of the LED light fixture 10. For example, in other embodiments the various elements listed directly above may be formed of conductive polymers, other conductive metals, or any other material known to those skilled in the art that is suitable for the specific application of the LED light fixture 10.

The plating 38 used to coat the power connections 31a, ground connections 31b, thermal vias 28, and electrical lead apertures 26 may be any suitable plating 38 known to those skilled in the art suitable for the particular application of the LED lighting fixture 10. The exemplary embodiment uses tin for the plating 38, but gold, silver, or other materials may be used within the scope of the present invention. Furthermore, different plating 38 may be used for different elements. For example, in an embodiment not pictured herein, tin may be used for the plating 38 on the electrical lead apertures 26, gold may be used for the plating 38 of the thermal vias 28, etc.

The LED lighting fixture 10 is applicable to an infinite number of design configurations for an infinite number of applications without departing from the spirit and scope of the present disclosure. For example, the use of thermal vias 28 to cool the PCB 20 may be employed for LED lighting fixtures 10 used in automobile lights, traffic signal lights, high bay lights, flashlights, or any other application. The voltage and amperage of the power supply, number of LEDs 40, configuration of LEDs 40 on the PCB 20, and presence of a lens (not shown) and/or lens type are design considerations, whereas the placement, size, configuration, and existence of thermal vias 28 is directed to heat dissipation.

It should be noted that the present invention is not limited to the specific embodiments pictured and described herein, but is intended to apply to all similar apparatuses for lighting systems having LEDs therein or any similar methods for dissipating heat from PCBs 20. Modifications and alterations from the described embodiments will occur to those skilled in the art without departure from the spirit and scope of the present invention.

1. A light emitting diode (LED) light fixture comprising:
a. a printed circuit board (PCB) having a first and second side;
b. at least one LED pad, said at least one LED pad mounted on either said PCB first or second side;
c. a plurality of LEDs mounted on said first side of said PCB in electrical communication with said at least one LED pad; and
d. at least one thermal via positioned adjacent at least one LED of said plurality, wherein said at least one thermal via allows a flow of air between said PCB first and second sides, wherein said at least one thermal via is coated with a plating, and wherein said plating is in conductive thermal communication with said at least one LED pad.

2. A light emitting diode (LED) light fixture comprising:
a. a housing;
b. a power supply mounted adjacent said housing, wherein said power supply is capable of connection to an electrical energy source;
c. a printed circuit board (PCB) mounted within said housing having a first and a second side, wherein said PCB is configured to be connected to said power supply, wherein said PCB comprises:
i. a PCB substrate;
ii. at least one power conductive pathway affixed to said PCB substrate;
iii. at least one ground conductive pathway affixed to said PCB substrate;
iv. at least one LED pad affixed to said PCB substrate;
v. at least one resistor pad affixed to said PCB substrate;
vi. a plurality of electrical lead apertures extending from said PCB first side through said PCB substrate to said PCB second side, wherein said electrical lead apertures a coated with a plating; and
vii. a plurality of thermal vias extending from said PCB first side through said PCB substrate to said PCB second side, wherein said thermal vias are coated with a plating;
d. at least one resistor electrically connected to said at least one power conductive pathway and said at least one resistor pad through two electrical lead apertures of said plurality;
e. at least one LED electrically connected to said at least one LED pad and said at least one resistor pad through two electrical lead apertures of said plurality; and
f. at least one LED electrically connected to at least two adjacent LED pads through two electrical lead apertures of said plurality, wherein said plurality of thermal vias and said at least one LED are configured to dissipate heat through the PCB first side, PCB second side, and said plurality of thermal vias.

3. The LED light fixture according to claim 2 wherein said PCB is further defined as having three LED board sections, wherein each said LED board section is electrically connected to said power supply through a power conductive pathway and a ground conductive pathway.

4. The LED light fixture according to claim 3 wherein each said LED board section is further defined as including a plurality of LED circuits.

5. The LED light fixture according to claim 4 wherein each LED circuit comprises:
a. a first resistor pad on said PCB first side;
b. a second resistor pad on said PCB second side;
c. a first LED pad adjacent said first resistor pad;
d. a second LED pad adjacent said second resistor pad;
e. a resistor electrically connecting said first and second resistor pads to said power conductive pathway;
f. a first LED, wherein said first LED electrically connects said first and second resistor pads to said first and second LED pads; and
g. a plurality of intermediate LED pads, wherein each intermediate LED pad is electrically connected to either an adjacent intermediate LED pad or said ground conductive pathway by at least one intermediate LED.

6. The LED light fixture according to claim 5 wherein said LED circuit is further defined as comprising a total of seven LEDs.

7. The LED light fixture according to claim 6 wherein said plurality of thermal vias is further defined as including three thermal vias for each LED.

8. The LED light fixture according to claim 7 wherein said three thermal vias are positioned on the portion of LED pad having highest amount of thermal energy in the absence of said thermal vias.

9. The LED light fixture according to claim 2 wherein the arrangement of LEDs is non-linear.

10. The LED light fixture according to claim 2 wherein the diameter of said plurality of thermal vias varies from one thermal via to the next.

11. The LED light fixture according to claim 2 wherein said PCB substrate is further defined as being constructed of an epoxy glass.

12. The LED light system according to claim 2, wherein said PCB is further defined as being constructed from a group including glass fiber mat, nonwoven material, resin, FR-2 (Phenolic cotton paper), FR-3 (Cotton paper and epoxy), FR-4 (Woven glass and epoxy), FR-5 (Woven glass and epoxy), FR-6 (Matte glass and polyester), G-10 (Woven glass and epoxy), CEM-1 (Cotton paper and epoxy), CEM-2 (Cotton paper and epoxy), CEM-3 (Woven glass and epoxy), CEM-4 (Woven glass and epoxy), CEM-5 (Woven glass and polyester), polyimide, Teflon, ceramics, and combinations thereof.

13. A light emitting diode (LED) circuit comprising:
a. a printed circuit board (PCB), wherein said PCB has a first and a second side, said PCB comprising:
i. a PCB substrate;
ii. at least one power conductive pathway positioned on either said PCB first or second side configured for electrical connection to a power supply;
iii. at least one ground conductive pathway positioned on either said PCB first or second side configured for electrical connection to a power supply;
iv. at least one resistor pad positioned on either said PCB first or second side;
v. at least one LED pad positioned on either said PCB first or second side;
vi. a plurality of electrical lead apertures, wherein said lead apertures extend from said PCB first side through said PCB substrate to said PCB second side; and
vii. a plurality of thermal vias, wherein each said thermal via extends from said PCB first side through said PCB substrate to said PCB second side, wherein each said thermal via is positioned either in said at least one LED pad or said at least one resistor pad, wherein each said thermal via is coated with a plating, and wherein each said thermal via is in thermal communication with either said at least one LED pad or said at least one resistor pad;
b. at least one resistor, wherein said resistor electrically connects two lead apertures of said plurality of lead apertures;
c. at least one LED, wherein said at least one LED electrically connects two electrical lead apertures of said plurality of electrical lead apertures, wherein said at least one power conductive pathway, at least one ground conductive pathway, at least one resistor pad, at least one LED pad, plurality of electrical lead apertures, at least one resistor, and at least one LED are configured so that a plurality of LEDs may be electrically connected in series.

14. The LED circuit according to claim 12 wherein said LED circuit is further defined as including one resistor pad and twelve LED pads.

15. The LED circuit according to claim 13 wherein said LED circuit is further defined as including seven LEDs electrically connected in series.

16. A printed circuit board (PCB) for a light emitting diode (LED) light fixture, wherein said PCB has a first and second side, said printed circuit board comprising:
a. a PCB substrate;
b. at least one power conductive pathway positioned on at least said PCB first side, wherein said power conductive pathway is configured to be connected to an electrical energy source at a power connection;
c. at least one ground conductive pathway positioned on at least said PCB first side, wherein said power conductive pathway is configured to be connected to an electrical energy source at a ground connection;
d. a first and a second resistor pad, wherein said first resistor pad is positioned on said PCB first side, and wherein said second resistor pad is positioned on said PCB second side;
e. a first and a second LED pad, wherein said first LED pad is positioned on said printed circuit board first side adjacent said first resistor pad, and wherein said second LED pad is positioned on said PCB first side adjacent said second resistor pad;
f. a first, a second, a third, a fourth, a fifth, and a sixth electrical lead aperture, wherein said lead apertures extend from said PCB first side through said PCB substrate to said PCB second side, wherein said first electrical lead aperture is positioned in said power conductive pathway, wherein said second and third electrical lead apertures are positioned in said first and second resistor pads, wherein said fourth and fifth electrical lead apertures are positioned in said first and second LED pads, and wherein said sixth electrical lead aperture is positioned in said ground conductive pathway;
g. at least one resistor, wherein said resistor electrically connects said first electrical lead aperture to said second electrical lead aperture;
h. a first and a second LED, wherein said first and second LEDs have a first and a second LED lead, respectively, wherein said first LED lead of said first LED is positioned within said third electrical lead aperture, wherein said second LED lead of said first LED is positioned within said fourth electrical lead aperture, wherein said first LED lead of said second LED is positioned within said fifth electrical lead aperture, and wherein said second LED lead of said second LED is positioned within said sixth electrical lead aperture; and
i. a plurality of thermal vias, wherein each said thermal via extends from said PCB first side through said PCB substrate to said PCB second side, wherein each said thermal via is positioned either in said first and second LED pads or said first and second resistor pads, and wherein each said thermal via is in thermal communication with either said first and second LED pads or said first and second resistor pads.

17. The PCB according to claim 15 further comprising:
a. a plurality of intermediate LED pads positioned between said first LED pad and said ground conductive pathway on said PCB first side;
b. a plurality of intermediate LED pads positioned on said PCB second side mirroring the position of said plurality of intermediate LEDpas on said PCB first side;
c. a plurality of intermediate LEDs electrically connecting said plurality of intermediate LED pads in series.

18. A method of dissipating heat generated by a light emitting diode (LED) light fixture comprising:
a. placing a plurality of LED pads on a printed circuit board (PCB), wherein said PCB is configured to be connected to a power supply;
b. placing at least one resistor pad on said PCB;
c. attaching at least one resistor to said at least one resistor pad and said power supply;
d. attaching at least one LED to said at least one LED pad of said plurality and to said at least one resistor pad;
e. attaching at least one LED to two adjacent LED pads of said plurality; and
f. positioning at least one thermal via in at least one LED pad of said plurality adjacent said at least one LED such that said at least one thermal via is in thermal communication with said at least one LED pad of said plurality.

19. The method of dissipating heat generated by an LED light fixture according to claim 18 wherein said method further comprises analytically determining what area on said LED pad will possess the most thermal energy during use, and subsequently positioning said at least one thermal via adjacent that area.

20. The method of dissipating heat generated by an LED light fixture according to claim 18 wherein said method further comprises optimizing the number and diameter of said at least one thermal via for cost and heat dissipation efficiency.

21. The method of dissipating heat generated by an LED light fixture according to claim 18 further comprising determining the quantity and magnitude of ambient air flow required to dissipate sufficient heat so that said at least one LED performs optimally.
